(19) United States
(12) Patent Application Publication
(10) Pub. No.: US 2016/0209285 A1
(43) Pub. Date: Jul. 21, 2016

(54) PRESSURE SENSOR, METHOD OF MANUFACTURING PRESSURE SENSOR, ALTIMETER, ELECTRONIC APPARATUS, AND MOVING OBJECT

(71) Applicant: Seiko Epson Corporation, Tokyo (JP)

(72) Inventor: Satoshi NAKAJIMA, Okaya (JP)

(21) Appl. No.: 14/995,480

(22) Filed: Jan. 14, 2016

(30) Foreign Application Priority Data
Jan. 20, 2015 (JP) 2015-008246
Jan. 20, 2015 (JP) 2015-008360

(51) Int. Cl. G01L 9/00; G01C 5/06

(52) U.S. Cl. CPC G01L 9/0054; G01C 5/06

(57) ABSTRACT

A pressure sensor includes a pressure sensor element having a pressure receiving surface and a filler (a resin section) disposed to surround the pressure sensor element. The filler includes a first portion that is at least in contact with the pressure receiving surface and a second portion located around the first portion and surrounding the first portion and the pressure sensor element. A curing rate of the first portion is higher than a curing rate of the second portion.

### CROSS REFERENCE

This application claims benefit of Japanese Applications JP 2015-008246, filed on Jan. 20, 2015 and JP 2015-008360, filed on Jan. 20, 2015. The disclosures of the prior applications are hereby incorporated by reference herein in their entirety.

### BACKGROUND

1. Technical Field

The present invention relates to a pressure sensor, a method of manufacturing the pressure sensor, an altimeter, an electronic apparatus, and a moving object.

2. Related Art

There has be known a pressure sensor including a sensor chip that detects pressure and generates an electric signal corresponding to a detection value of the pressure, a package that houses the sensor chip, and inert liquid that surrounds the sensor chip in the package and propagates the pressure to the sensor chip (see, for example, JP-A-9-126920 (Patent Literature 1)). In the pressure sensor, the sensor chip includes a diaphragm that bends with received pressure and a pressure reference chamber provided on the diaphragm. The pressure outside the package acts on the diaphragm via the inert liquid. The pressure applied to the pressure sensor is detected from a deflection amount of the diaphragm due to the application of the pressure to the diaphragm.

However, in the pressure sensor having such a configuration, for example, air bubbles easily occur when the inert liquid is filled in the package. If the air bubbles come into contact with a pressure receiving surface of the diaphragm, pressure detection accuracy is deteriorated.

### SUMMARY

An advantage of some aspects of the invention is to provide a pressure sensor in which air bubbles do not easily come into contact with a pressure receiving surface of the diaphragm and deterioration in pressure detection accuracy can be reduced, a method of manufacturing the pressure sensor, and an altimeter, an electronic apparatus, and a moving object including the pressure sensor.

The invention can be implemented as the following application examples.

### Application Example 1

A pressure sensor according to this application example includes: a pressure sensor element having a pressure receiving surface; and a resin section disposed around the pressure sensor element and formed of curable resin. The resin section includes a first portion disposed at least on the pressure receiving surface and a second portion separate from the first portion. A curing rate of the first portion is higher than a curing rate of the second portion.

With this configuration, it is possible to obtain the pressure sensor in which air bubbles less easily come into contact with the pressure receiving surface and deterioration in pressure detection accuracy can be reduced.

### Application Example 2

In the pressure sensor according to this application example, it is preferable that the first portion and the second portion respectively contain resin materials of the same kind.

With this configuration, it is easy to adjust the curing rates (hardness levels) of the first portion and the second portion.

### Application Example 3

In the pressure sensor according to this application example, it is preferable that the pressure sensor element includes a recess, the bottom surface of which is the pressure receiving surface, and the first portion is disposed to be connected to an inner side surface joined to the bottom surface in the recess.

With this configuration, air bubbles much less easily come into contact with the pressure receiving surface.

### Application Example 4

In the pressure sensor according to this application example, it is preferable that the curable resin is cured by heat.

With this configuration, it is possible to easily perform curing of the curable resin.

### Application Example 5

In the pressure sensor according to this application example, it is preferable that the curable resin is cured by light.

With this configuration, it is possible to easily perform curing of the curable resin.

### Application Example 6

In the pressure sensor according to this application example, it is preferable that the pressure sensor further includes a package configured to house the pressure sensor element and the resin section.

With this configuration, it is possible to protect the pressure sensor element and store the curable resin in the package.

### Application Example 7

In the pressure sensor according to this application example, it is preferable that the package has an opening, and the pressure sensor element is disposed with the pressure receiving surface directed to a direction different from the direction of the opening.

With this configuration, it is possible to protect the pressure receiving surface.

### Application Example 8

In the pressure sensor according to this application example, it is preferable that the first portion is subjected to defoaming treatment.

With this configuration, air bubbles much less easily come into contact with the pressure receiving surface.

### Application Example 9

In the pressure sensor according to this application example, it is preferable that the pressure sensor element includes a diaphragm having the pressure receiving surface and a pressure reference chamber disposed on the opposite side of the pressure receiving surface with respect to the diaphragm, the resin section further includes at least a third portion disposed on the opposite side of the diaphragm with respect to the pressure reference chamber, the second portion is disposed around the first portion and the third portion, and a curing rate of the first portion and a curing rate of the third portion are higher than a curing rate of the second portion.

With this configuration, it is possible to obtain the pressure sensor in which air bubbles less easily come into contact with the pressure receiving surface of the diaphragm, a stress balance on both sides (the diaphragm side and the opposite side of the diaphragm) of the pressure reference chamber less easily changes, and deterioration in pressure detection accuracy can be reduced.

### Application Example 10

In the pressure sensor according to this application example, it is preferable that a difference between the curing rate of the first portion and the curing rate of the third portion is smaller than a difference between the curing rate of the first portion and the curing rate of the second portion and a difference between the curing rate of the third portion and the curing rate of the second portion.

With this configuration, the stress balance on both the side (the diaphragm side and the opposite side of the diaphragm) of the pressure reference chamber is more stabilized.

### Application Example 11

In the pressure sensor according to this application example, it is preferable that the first portion, the second portion, and the third portion respectively contain resin materials of the same kind.

With this configuration, it is easy to adjust curing rates (hardness levels) of the first portion, the second portion, and the third portion.

### Application Example 12

A method of manufacturing a pressure sensor according to this application example includes: preparing a pressure sensor element having a pressure receiving surface, a package, first curable resin, and second curable resin including a component same as a component of the first curable resin; disposing the first curable resin on the pressure receiving surface; curing the first curable resin; disposing the pressure sensor element in the package; disposing the second curable resin in the package to surround the pressure sensor element and the first curable resin; and curing the first curable resin and the second curable resin disposed in the package.

With this configuration, it is possible to obtain the pressure sensor in which air bubbles less easily come into contact with the pressure receiving surface and deterioration in pressure detection accuracy can be reduced.

### Application Example 13

A method of manufacturing a pressure sensor according to this application example includes: preparing a pressure sensor element including a diaphragm having a pressure receiving surface and a pressure reference chamber disposed on the opposite side of the pressure receiving surface with respect to the diaphragm, a package, and first curable resin, second curable resin, and third curable resin including the same component one another; disposing the first curable resin on the pressure receiving surface and disposing the third curable resin on the opposite side of the diaphragm with respect to the pressure reference chamber; curing the first curable resin and the third curable resin; disposing the pressure sensor element in the package; disposing the second curable resin in the package to surround the pressure sensor element, the first curable resin, and the third curable resin; and curing the first curable resin, the second curable resin, and the third curable resin disposed in the package.

With this configuration, it is possible to obtain the pressure sensor in which air bubbles less easily come into contact with the pressure receiving surface of the diaphragm, a stress balance on both sides (the diaphragm side and the opposite side of the diaphragm) of the pressure reference chamber less easily changes, and deterioration in pressure detection accuracy can be reduced.

### Application Example 14

In the method of manufacturing the pressure sensor according to this application example, it is preferable that the manufacturing method further includes defoaming the first curable resin disposed on the pressure receiving surface before the curing the first curable resin.

With this configuration, since air bubbles in the first curable resin can be removed, it is possible to effectively reduce contact of the pressure receiving surface and the air bubbles.

### Application Example 15

An altimeter according to this application example includes the pressure sensor according to the application example.

With this configuration, it is possible to obtain the altimeter having high reliability.

### Application Example 16

An electronic apparatus according to this application example includes the pressure sensor according to the application example.

With this configuration, it is possible to obtain the electronic apparatus having high reliability.

### Application Example 17

A moving object according to this application example includes the pressure sensor according to the application example.

With this configuration, it is possible to obtain the moving object having high reliability.

### BRIEF DESCRIPTION OF THE DRAWINGS

The invention will be described with reference to the accompanying drawings, wherein like numbers reference like elements.

FIG. 1 is a sectional view of a pressure sensor according to a first embodiment of the invention.

FIG. 2 is a plan view of a flexible wiring board included in the pressure sensor shown in FIG. 1.

FIG. 3 is a sectional view of a pressure sensor element included in the pressure sensor shown in FIG. 1.

FIG. 4 is a plan view showing a pressure sensor section included in the pressure sensor element shown in FIG. 3.

FIG. 5 is a diagram showing a bridge circuit including the pressure sensor section shown in FIG. 4.

FIGS. 6A to 6C are sectional views for explaining a method of manufacturing the pressure sensor shown in FIG. 1.

FIGS. 7A and 7B are sectional views for explaining the method of manufacturing the pressure sensor shown in FIG. 1.

FIG. 8 is a sectional view of a pressure sensor according to a second embodiment of the invention.

FIG. 9 is a sectional view of a pressure sensor according to a third embodiment of the invention.

FIG. 10 is a sectional view of a pressure sensor according to a fourth embodiment of the invention.

FIG. 11 is a plan view of a flexible wiring board included in the pressure sensor shown in FIG. 10.

FIG. 12 is a sectional view of a pressure sensor element included in the pressure sensor shown in FIG. 10.

FIGS. 13A to 13C are sectional views for explaining a method of manufacturing the pressure sensor shown in FIG. 10.

FIGS. 14A and 14B are sectional views for explaining the method of manufacturing the pressure sensor shown in FIG. 10.

FIG. 15 is a sectional view for explaining the method of manufacturing the pressure sensor shown in FIG. 10.

FIG. 16 is a sectional view of a pressure sensor according to a fifth embodiment of the invention.

FIG. 17 is a sectional view of a pressure sensor according to a sixth embodiment of the invention.

FIG. 18 is a perspective view showing an example of an altimeter of the invention.

FIG. 19 is a front view showing an example of an electronic apparatus according to the invention.

FIG. 20 is a perspective view showing an example of a moving object according to the invention.

### DESCRIPTION OF EXEMPLARY EMBODIMENTS

A pressure sensor, a method of manufacturing the pressure sensor, an altimeter, an electronic apparatus, and a moving object according to the invention are explained in detail below with reference to embodiments shown in the accompanying drawings.

### First Embodiment

First, a pressure sensor according to a first embodiment of the invention is explained.

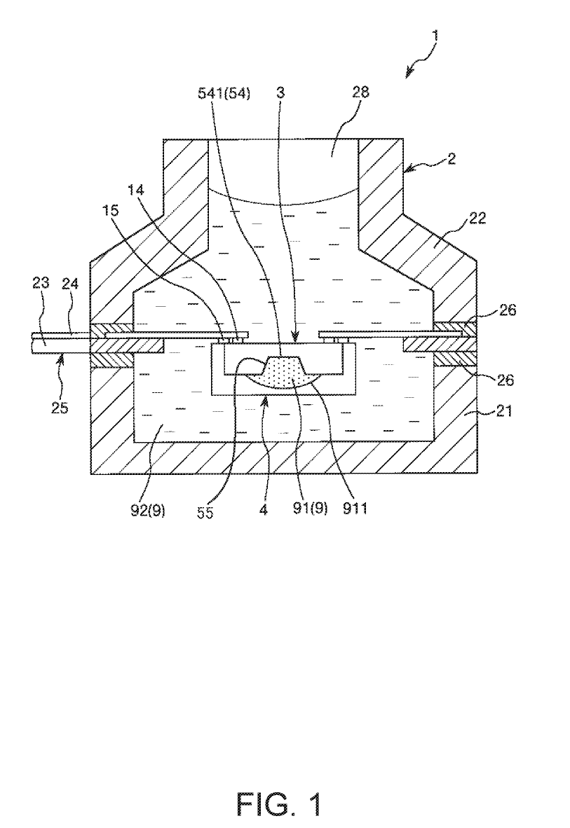

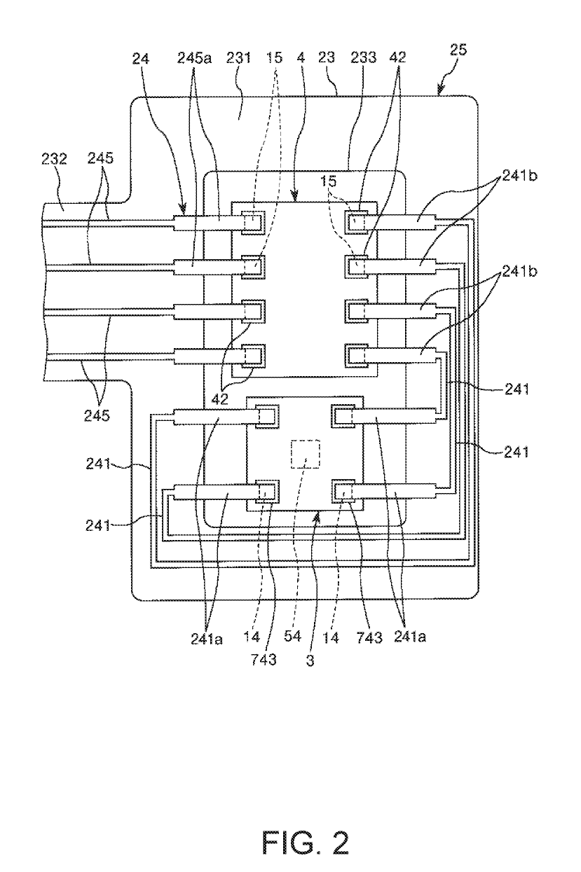

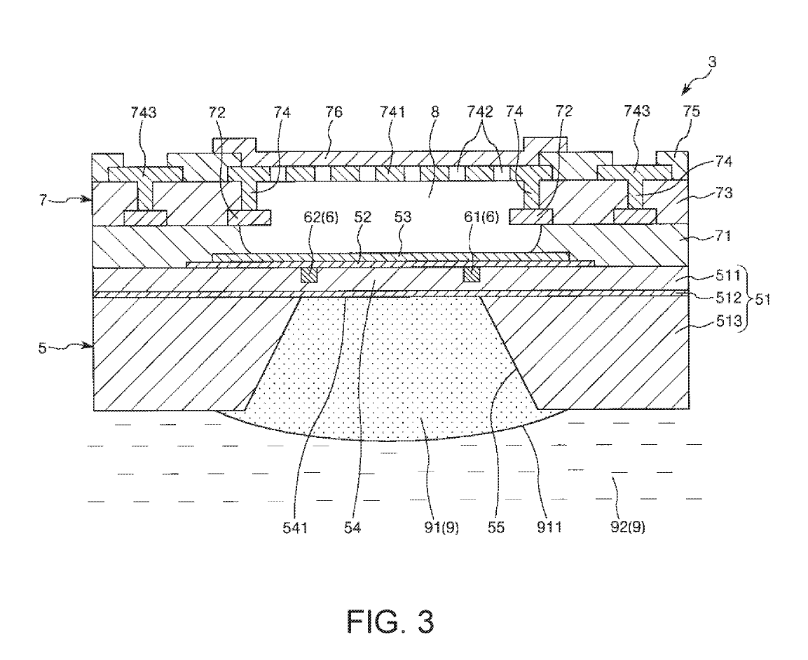

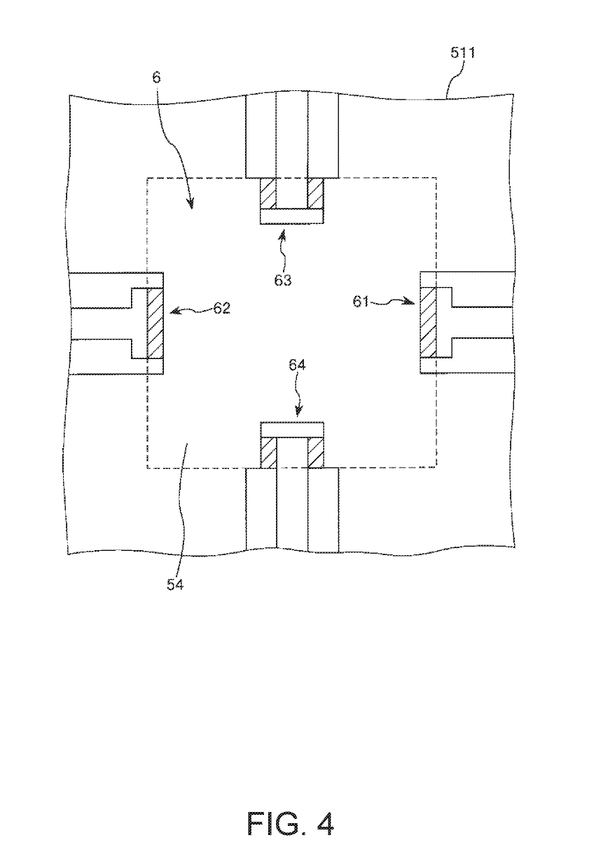

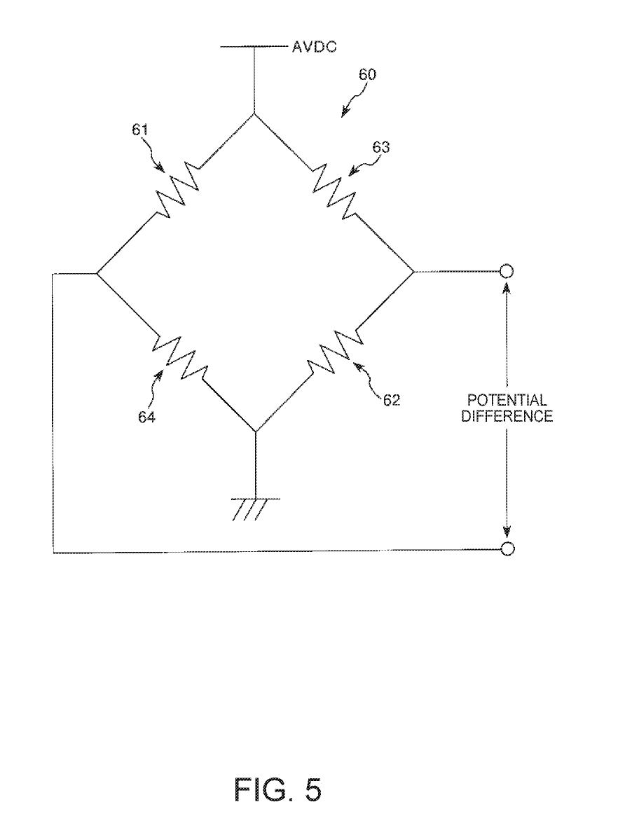

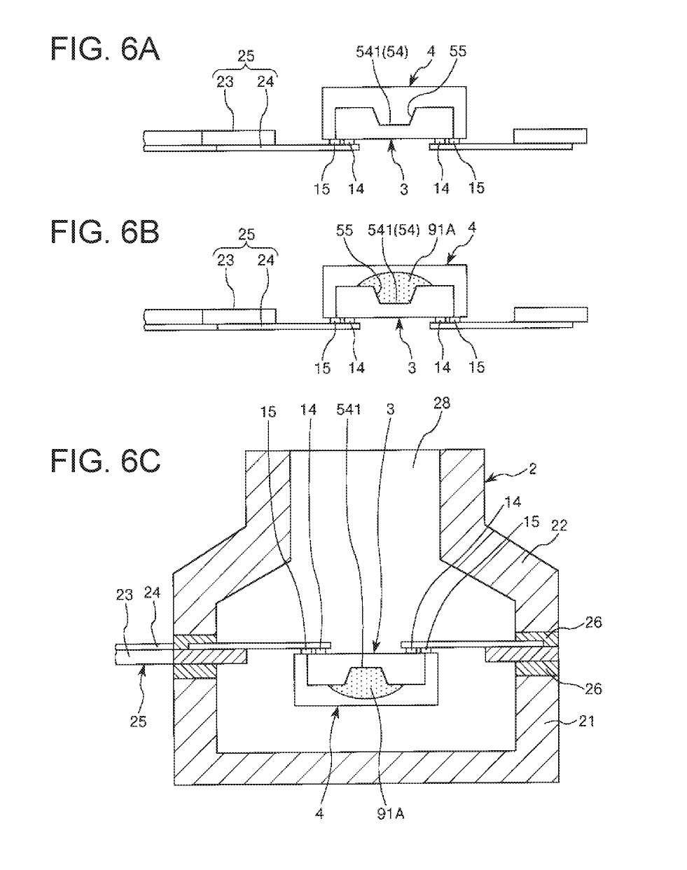

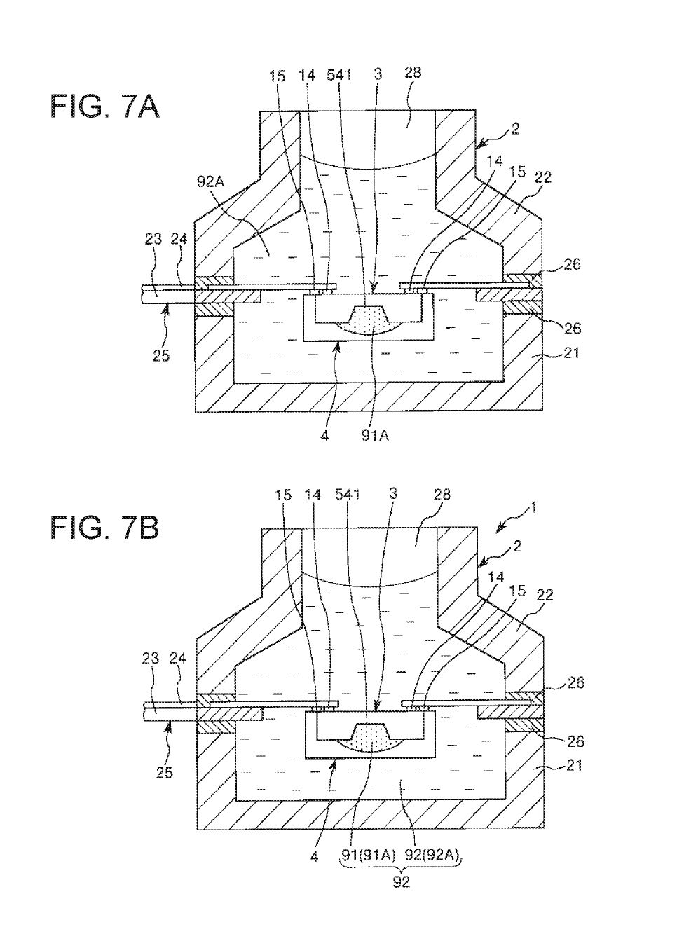

FIG. 1 is a sectional view of the pressure sensor according to the first embodiment. FIG. 2 is a plan view of a flexible wiring board included in the pressure sensor shown in FIG. 1. FIG. 3 is a sectional view of a pressure sensor element included in the pressure sensor shown in FIG. 1. FIG. 4 is a plan view showing a pressure sensor section included in the pressure sensor element shown in FIG. 3. FIG. 5 is a diagram showing a bridge circuit including the pressure sensor section shown in FIG. 4. FIGS. 6A to 6C and FIGS. 7A and 7B are sectional views for explaining a method of manufacturing the pressure sensor shown in FIG. 1. Note that, in the following explanation, an upper side in FIG. 3 is referred to as “upper” as well and a lower side is referred to as “lower” as well.

The pressure sensor 1 shown in FIG. 1 includes a pressure sensor element 3, an IC chip 4 electrically connected to the pressure sensor element 3, a package 2 that houses both of the pressure sensor element 3 and the IC chip 4, and a filler 9 that surrounds the pressure sensor element 3 and the IC chip 4 in the package 2. These sections are explained below in order.

### Package

The package 2 has a function of housing the pressure sensor element 3 in an internal space 28 formed on the inside thereof and fixing the pressure sensor element 3. The pressure sensor element 3 is protected by the package 2. The filler 9 is easily disposed around the pressure sensor element 3.

As shown in FIG. 1, the package 2 includes a base 21, a housing 22, and a flexible wiring board 25. The package 2 is configured by joining the base 21, the housing 22, and the flexible wiring board 25 to one another to sandwich the flexible wiring board 25 with the base 21 and the housing 22. The joining of the base 21 and the flexible wiring board 25 and the joining of the housing 22 and the flexible wiring board 25 are performed via an adhesive layer 26 formed by an adhesive.

The base 21 configures the bottom surface of the package 2 and is formed in a box shape. A constituent material of the base 21 is not particularly limited. Examples of the constituent material include various ceramics like oxide ceramics such as alumina, silica, titania, and zirconia and nitride ceramics such as silicon nitride, aluminum nitride, and titanium nitride and insulative materials such as various resin materials like polyethylene, polyamide, polyimide, polycarbonate, acrylic resin, ABS resin, and epoxy resin. One kind of these materials can be used or two or more kinds of these materials can be used in combination. Among these materials, the constituent material is desirably the various ceramics. Consequently, it is possible to obtain the package 2 having excellent mechanical strength. Note that, besides, a plan view shape of the base 21 may be, for example, a circular shape, a rectangular shape, or a polygonal shape having five or more corners.

The housing 22 configures a lid section of the package 2. In this embodiment, the entire shape of the housing 22 is formed in a cylindrical shape. The housing 22 includes a first part, the outer diameter and the inner diameter of which gradually decrease from the lower end toward the upper end up to height halfway in package height, and a second part, the outer diameter and the inner diameter of which are substantially fixed from the halfway height toward the upper end. As a constituent material of the housing 22, materials same as the materials described above as the examples of the constituent materials of the base 21 can be used. Note that the shape of the housing 22 is not particularly limited.

The flexible wiring board 25 is located between the base 21 and the housing 22. The flexible wiring board 25 has a function of supporting the pressure sensor element 3 and the IC chip 4 in the package 2 and extracting electric signals of the pressure sensor element 3 and the IC chip 4 to the outside of the package 2. The flexible wiring board 25 is configured by a base material 23 having flexibility and a wire 24 formed on the upper surface side of the base material 23.

As shown in FIG. 2, the base material 23 includes a frame section 231 formed in a substantially square frame shape and having an opening section 233 in the center portion and a belt body 232 integrally formed in a belt shape to project to the outer side of the frame section 231 on one side of the frame section 231. A constituent material of the base material 23 is not particularly limited as long as the constituent material is a material having flexibility. Examples of the constituent material include polyimide, polyethylene terephthalate (PET), polyethylene naphthalate (PEN), and polyether sulphone (PES). One kind of these materials can be used or two or more kinds of these materials can be used in combination.

The wire 24 has electric conductivity. As shown in FIG. 2, the wire 24 is provided (drawn around) from the frame section 231 to the belt body 232. The wire 24 includes four wiring sections 241 that support the pressure sensor element 3 and electrically connect the pressure sensor element 3 and the IC chip 4 and four wiring sections 245 that support the IC chip 4 and are electrically connected to the IC chip 4. The four wiring sections 245 are drawn out to the outside of the package 2 via the belt body 232.

In the four wiring sections 241, end portions on the pressure sensor element 3 side are respectively flying leads 241a. Similarly, end portions on the IC chip 4 side are flying leads 241b. The four flying leads 241a are provided such that the distal end sides thereof project into the opening section 233. In distal end portions, the flying leads 241a are electrically connected to the pressure sensor element 3 via conductive fixed members 14. The pressure sensor element 3 is separated from the frame section 231 and supported by the flying leads 241a. Similarly, the four flying leads 241b are provided such that the distal end sides thereof project into the opening section 233. In distal end portions, the flying leads 241b are electrically connected to the IC chip 4 via conductive fixed members 15. By adopting the configuration explained above, the pressure sensor element 3 and the IC chip 4 are electrically connected via the four wiring sections 241. Communication can be performed between the pressure sensor element 3 and the IC chip 4. Note that the fixed members 14 and 15 are not particularly limited as long as the fixed members 14 and 15 have electric conductivity. For example, a metal brazing material such as solder, a metal bump such as a gold bump, and a conductive adhesive can be used.

On the other hand, in the four wiring sections 245, proximal end sides are provided in the belt body 232 and the distal end sides are provided in the frame section 231. Distal end portions of the four wiring sections 245 are flying leads 245a. The four flying leads 245a are provided such that the distal end sides thereof project into the opening section 233. In distal end portions, the flying leads 245a are electrically connected to the IC chip 4 via the conductive fixed members 15. The IC chip 4 is separated from the frame section 231 and supported by the flying leads 245a and the flying leads 241b.

With the package 2 having such a configuration, for example, by electrically connecting a motherboard or the like of an electronic apparatus or a moving object explained below to the end portions of the wiring sections 245, it is possible to extract electric signals of the pressure sensor element 3 and the IC chip 4 to the outside of the package 2.

Note that the number of wiring sections included in the wire 24 is not particularly limited and only has to be set as appropriate according to the number of connection terminals 743 explained below provided in the pressure sensor element 3 and the number of connection terminals 42 explained below provided in the IC chip 4. A constituent material of the wire 24 is not particularly limited as long as the constituent material has electric conductivity. Examples of the constituent material include metal such as Ni, Pt, Li, Mg, Sr, Ag, Cu, Co, and Al, alloys such as MgAg, AlLi, and CuLi containing these kinds of metal, and oxides such as ITO and SnO₂. One kind of these materials can be used or two or more kinds of these materials can be used in combination.

### Pressure Sensor Element

As shown in FIG. 3, the pressure sensor element 3 includes a substrate 5, a pressure sensor section 6, an element peripheral structure 7, a hollow section 8, and a not-shown semiconductor circuit. These sections are explained below in order.

The substrate 5 is formed in a plate shape and configured by stacking, in written order, a semiconductor substrate 51 configured by an SOI substrate (a substrate in which a first Si layer 511, an SiO₂ layer 512, and a second Si layer 513 are stacked in this order), a first insulating film 52 configured by a silicon oxide film (SiO₂ film) on the semiconductor substrate 51, and a second insulating film 53 configured by a silicon nitride film (SiN film). However, the semiconductor substrate 51 is not limited to the SOI substrate. For example, a silicon substrate can be used.

In the semiconductor substrate 51, a diaphragm 54 thinner than a peripheral portion and deflectively deformed by received pressure is provided. The diaphragm 54 is formed by providing a bottomed recess 55 in the lower surface of the semiconductor substrate 51. The lower surface (the bottom surface of the recess 55) is a pressure receiving surface 541.

A not-shown semiconductor circuit (a circuit) is fabricated on and above the semiconductor substrate 51. The semiconductor circuit includes an active element such as a MOS transistor and circuit elements such as a capacitor, an inductor, a resistor, a diode, and a wire formed according to necessity.

The pressure sensor section 6 includes, as shown in FIG. 4, four piezoelectric resistance elements 61, 62, 63, and 64 provided in the diaphragm 54. The piezoelectric resistance elements 61 to 64 are electrically connected to one another via a wire or the like and configure a bridge circuit 60 (a Wheatstone bridge circuit) shown in FIG. 5 to be connected to a semiconductor circuit. A driving circuit (not shown in the figure) that supplies a driving voltage AVDC is connected to the bridge circuit 60. The bridge circuit 60 outputs a signal (a voltage) corresponding to a resistance value change of the piezoelectric resistance elements 61, 62, 63, and 64 based on deflection of the diaphragm 54. Note that the piezoelectric resistance elements 61, 62, 63, and 64 are respectively configured by, for example, doping (diffusing or injecting) impurities such as phosphorus or boron into the first Si layer 511. The wire that connect the piezoelectric resistance elements 61 to 64 is configured by, for example, doping (diffusing or injecting) impurities such as phosphorus or boron into the first Si layer 511 at concentration higher than the concentration of the impurities doped in the piezoelectric resistance elements 61 to 64.

The element peripheral structure 7 is formed to define the hollow section 8. The element peripheral structure 7 includes, as shown in FIG. 3, an interlayer insulating film 71, a wiring layer 72 formed on the interlayer insulating film 71, an interlayer insulating film. 73 formed on the wiring layer 72 and the interlayer insulating film 71, a wiring layer 74 formed on the interlayer insulating film 73, a surface protection film 75 formed on the wiring layer 74 and the interlayer insulating film 73, and a sealing layer 76. The wiring layer 74 includes a coating layer 741 including a plurality of pores 742 that allow the inside and the outside of the hollow section 8 to communicate with each other. The sealing layer 76 disposed on the coating layer 741 seals the pores 742. The wiring layers 72 and 74 include wiring layers formed to surround the hollow section 8 and wiring layers configuring wires of the semiconductor circuit. The semiconductor circuit is drawn out to the upper surface of the pressure sensor element 3 by the wiring layers 72 and 74. Parts of the wiring layer 74 are connection terminals 743. The connection terminals 743 are electrically connected to the flying leads 241a via the fixed members 14 (see FIG. 2).

The interlayer insulating films 71 and 73 are not particularly limited. For example, an insulating film such as a silicon oxide film (SiO₂ film) can be used. The wiring layers 72 and 74 are not particularly limited. For example, a metal film such as an aluminum film can be used. The sealing layer 76 is not particularly limited. Metal films of Al, Cu, W, Ti, TiN, and the like can be used. The surface protection film 75 is not particularly limited. Films having resistance for protecting an element from moisture, dust, scratches, and the like such as a silicon oxide film, a silicon nitride film, a polyimide film, and an epoxy resin film can be used.

The hollow section 8 defined by the substrate 5 and the element peripheral structure 7 is a closed space and functions as a pressure reference chamber for providing a reference value of pressure detected by the pressure sensor element 3. The hollow section 8 is located on the opposite side of the pressure receiving surface 541 of the diaphragm 54 and disposed to overlap the diaphragm 54 in plan view of the pressure sensor element 3. The hollow section 8 is in a vacuum state (e.g., 10 Pa or less). Consequently, the pressure sensor element 3 can be used as a so-called “absolute pressure sensor element” that detects pressure with reference to the vacuum state. However, the hollow section 8 does not have to be in the vacuum state. For example, the hollow section 8 may be in an atmospheric pressure state, may be in a decompressed state in which air pressure is lower than the atmospheric pressure, or may be a pressurized state in which air pressure is higher than the atmospheric pressure.

As shown in FIG. 1, the pressure sensor element 3 having the configuration explained above is housed in the package 2 in a posture in which the pressure receiving surface 541 of the diaphragm 54 is directed to the bottom side of the package 2. By adopting such disposition, for example, it is possible to protect the pressure receiving surface 541 from foreign matters intruding into the pressure sensor element 3 via the opening of the package 2. A first portion 91 explained below has a curved convex-shaped surface 911 protruding from the recess 55. Therefore, when a second curable resin 92A is filled in the package 2, air bubbles less easily remain on the bottom surface of the pressure sensor element 3 (air bubbles are guided to the surface 911 and naturally removed). Therefore, it is possible to further suppress air bubbles in the filler 9.

### IC Chip

The IC chip 4 includes, for example, a driving circuit for supplying a voltage to the bridge circuit 60, a temperature compensation circuit for performing temperature compensation of an output from the bridge circuit 60, a pressure detection circuit that calculates applied pressure from an output from the temperature compensation circuit, and an output circuit that converts an output from the pressure detection circuit into a predetermined output form (CMOS, LV-PECL, LVDS, etc.) and outputs the pressure. The IC chip 4 includes connection terminals 42 connected to the circuits. The connection terminals 42 are electrically connected to the flying leads 245a via the fixed members 15 (see FIG. 2). Note that the disposition of the driving circuit, the temperature compensation circuit, the pressure detection circuit, the output circuit, and the like is not particularly limited. For example, a part of the circuits (e.g., the driving circuit) may be formed in the semiconductor circuit in the pressure sensor element 3.

### Filler

As shown in FIG. 1, the filler 9 is filled in the internal space 28 of the package 2 and surrounds the pressure sensor element 3 and the IC chip 4 housed in the internal space 28. The pressure sensor element 3 and the IC chip 4 can be protected (from dust and water) and external stress (stress other than pressure) acting on the pressure sensor 1 can be reduced by the filler 9. Note that the pressure applied to the pressure sensor 1 acts on the pressure receiving surface 541 of the pressure sensor element 3 via the opening of the package 2 and the filler 9.

The filler 9 contains curable resin as a main component. That is, the filler 9 is a resin section mainly formed of the curable resin. The curable resin is particularly desirably thermosetting resin or photocurable resin (in particular, ultraviolet curable resin). Consequently, it is possible to more easily perform curing of the curable resin.

The filler 9 only has to be a substance having curability and softer than the pressure sensor element 3, the IC chip 4, and the package 2 and is, for example, in a liquid state or a gel state. As a specific example of the filler 9, for example, silicone oil, fluorine-based oil, and silicone gel can be used. Note that various fillers may be mixed in the filler 9, for example, for the purpose of improving thermal conductivity and the purpose of adjusting viscosity.

The filler 9 includes two portions (regions) having different curing rates (resin curing rates). Specifically, the filler 9 includes a first portion 91 that is in contact with the pressure receiving surface 541 of the pressure sensor element 3 and an inner side surface joined to the periphery of the pressure receiving surface 541 in the recess 55 and is disposed to fill the recess 55 and a second portion 92 located around the first portion 91 and surrounding the first portion 91 and the pressure sensor element 3. A curing rate of the first portion 91 is higher than a curing rate of the second portion 92. That is, the first portion 91 is harder (has lower penetration) than the second portion 92. Note that the first portion 91 and the second portion 92 contain resin materials of the same kind as main components. Only the curing rates (hardness levels) of the first portion 91 and the second portion 92 are substantially different.

By adopting such a configuration, air bubbles less easily come into contact with the pressure receiving surface 541. It is possible to reduce fluctuation and deterioration in pressure detection accuracy. Therefore, the pressure sensor 1 can show excellent pressure detection accuracy. Specifically, air bubbles sometimes occur in the filler 9 when the filler 9 is filled in the internal space 28. If the air bubbles move in the filler 9 and come into contact with the pressure receiving surface 541, the air bubbles act like a cushion. Pressure is not appropriately transmitted to the pressure receiving surface 541 in a portion where the air bubbles come into contact with the pressure receiving surface 541. Therefore, if the air bubbles come into contact with the pressure receiving surface 541, fluctuation and deterioration in pressure detection accuracy occur.

On the other hand, in the pressure sensor 1 in this embodiment, since the curing rate of the first portion 91 that covers the pressure receiving surface 541 is higher than the curing rate of the second portion 92. Therefore, for example, intrusion of air bubbles into the first portion 91 from the second portion 92 and movement of the air bubbles in the first portion 91 are effectively suppressed. Therefore, the air bubbles less easily come into contact with the pressure receiving surface 541. It is possible to reduce fluctuation and deterioration in pressure detection accuracy.

The curing rates of the first portion 91 and the second portion 92 are not particularly limited as long as the curing rate of the first portion 91 is higher than the curing rate of the second portion 92. Depending on materials, for example, the curing rate of the first portion 91 is desirably within a range of 40% or more and 90% or less and more desirably within a range of 50% or more and 80% or less. The curing rate of the second portion 92 is desirably within a range of 10% or more and 60% or less and more desirably within a range of 20% or more and 40% or less. By setting the curing rates of the first portion 91 and the second portion 92 in such a range, it is possible to set the second portion 92 to viscosity of a degree for not allowing the second portion 92 to flow out from the opening of the package 2. It is possible to set the first portion 91 to viscosity of a degree for not allowing air bubbles to move on the inside of the first portion 91.

The viscosities of the first portion 91 and the second portion 92 are not particularly limited as long as the viscosity of the first portion 91 is higher than the viscosity of the second portion 92. However, for example, the penetration of the first portion 91 is desirably within a range of 50 or more and 200 or less and is more desirably within a range of 150 or more and 200 or less. The penetration of the second portion 92 is desirably within a range of 100 or more and 250 or less and more desirably within a range of 200 or more and 250 or less. Consequently, it is possible to sufficiently soften the filler 9. Pressure applied to the pressure sensor 1 efficiently acts on the pressure receiving surface 541. It is possible to effectively suppress movement of air bubbles on the inside of the first portion 91. Note that measurement of a curing rate can be performed by measurement by an FT-IR, fluorescence measurement, and the like. Penetration can be measured by a method conforming to a test method specified by JIS K 2207.

In particular, in this embodiment, the first portion 91 and the second portion 92 are formed of materials of the same kind (the same resin materials). Therefore, the filler 9 has a simpler configuration. It is easier to adjust the curing rates of the first portion 91 and the second portion 92. In this embodiment, since the first portion 91 is disposed to fill the entire region of the recess 55, it is possible to set the second portion 92 sufficiently away from the pressure receiving surface 541. Therefore, the air bubbles much less easily come into contact with the pressure receiving surface 541. It is possible to further reduce the fluctuation and deterioration in the pressure detection accuracy. In this embodiment, since the first portion 91 is kept at a minimum enough for filling the entire region of the recess 55 (as shown in FIG. 3, the first portion 91 does not cover the entire region of the lower surface of the substrate 5, i.e., covers only the periphery of the recess 55 excluding edge portions of the lower surface), pressure is prevented from being less easily transmitted to the pressure receiving surface 541.

The first portion 91 is desirably subjected to defoaming treatment. Consequently, it is possible to remove air bubbles in the first portion 91. Therefore, it is possible to effectively prevent the air bubbles in the first portion 91 from coming into contact with the pressure receiving surface 541. Note that the defoaming treatment is not particularly limited. Examples of the deforming treatment include a method of performing evacuation explained in a manufacturing method below.

The configuration of the pressure sensor 1 is explained above.

A method of manufacturing the pressure sensor 1 is explained.

The method of manufacturing the pressure sensor 1 includes a step of preparing the pressure sensor element 3, the package 2, a first curable resin 91A, and a second curable resin 92A, a step of disposing the first curable resin 91A on the pressure receiving surface 541 of the pressure sensor 1, a step of curing (semi-curing) the first curable resin 91A, a step of disposing the pressure sensor element 3 in the package 2, a step of disposing the second curable resin 92A in the package 2 to surround the pressure sensor element 3 and the first curable resin 91A, and a step of curing (semi-curing) the first curable resin 91A and the second curable resin 92A disposed in the package 2.

The manufacturing method is explained below in detail. However, for convenience of explanation, the same thermosetting resin is used as the first curable resin 91A and the second curable resin 92A. The curing rates of the first curable resin 91A and the second curable resin 92A before being served for manufacturing are equal.

First, as shown in FIG. 6A, the pressure sensor element 3 and the IC chip 4 are connected to the flexible wiring board 25.

Subsequently, as shown in FIG. 6B, the first curable resin 91A enough for filling the recess 55 is supplied into the recess 55 in a state in which the pressure receiving surface 541 (the opening of the recess 55) is directed to the upper side in the vertical direction. The pressure sensor element 3 is disposed in a vacuum chamber in the state in which the pressure receiving surface 541 (the opening of the recess 55) is directed to the upper side in the vertical direction. The first curable resin 91A is defoamed by performing evacuation. Consequently, air bubbles are removed from the first curable resin 91A. Heat is applied to the first curable resin 91A to semi-cure the first curable resin 91A. For example, when the first curable resin 91A is silicone oil (having a curing rate of 0%), for example, the first curable resin 91A is desirably semi-cured under a condition of 150°×30 minutes. The curing rate of the first curable resin 91A at this point is not particularly limited. For example, the curing rate is desirably set to approximately 20% or more and 40% or less.

Subsequently, as shown in FIG. 6C, the flexible wiring board 25 is sandwiched by the base 21 and the housing 22. The flexible wiring board 25, the base 21, and the housing 22 are joined to one another by an adhesive. Consequently, the pressure sensor element 3 and the IC chip 4 are housed in the package 2.

Subsequently, as shown in FIG. 7A, the second curable resin 92A is filled in the internal space 28 of the package 2. The pressure sensor element 3 and the IC chip 4 are surrounded by the second curable resin 92A.

Subsequently, heat is applied to the first curable resin 91A and the second curable resin 92A under the same condition to semi-cure the first curable resin 91A and the second curable resin 92A. When the first curable resin 91A and the second curable resin 92A are silicone oil, the first curable resin 91A and the second curable resin 92A are semi-cured, for example, under a condition of 150°×30 minutes. The curing rate of the first curable resin 91A is not particularly limited. The curing rate is, for example, approximately 40% or more and 90% or less. The curing rate of the second curable resin 92A is, for example, approximately 10% or more and 60% or less. Note that, since the first curable resin 91A and the second curable resin 92A are the resin materials of the same kind, the first curable resin 91A, for which a curing time is long (curing is performed twice), has a higher curing rate than the second curable resin 92A, for which a curing time is short (curing is performed only once). Consequently, the filler 9 including the first portion 91 formed of the first curable resin 91A and the second portion 92 formed of the second curable resin 92A is obtained.

Consequently, the pressure sensor 1 is manufactured as shown in FIG. 7B.

According to the manufacturing method explained above, it is possible to manufacture the pressure sensor 1 with a relatively simple method. In particular, the manufacturing method includes the step of defoaming the first curable resin 91A before curing the first curable resin 91A. Therefore, air bubbles in the first portion 91 are removed and the pressure sensor 1 having higher pressure detection accuracy is obtained. Note that, in the manufacturing method explained above, the defoaming of the second curable resin 92A may be performed prior to the curing of the first curable resin 91A and the second curable resin 92A. Consequently, it is possible to sufficiently reduce the air bubbles in the filler 9.

Note that, in this embodiment, the thermosetting resin is used as the first curable resin 91A and the second curable resin 92A. However, photocurable resin may be used as the first curable resin 91A and the second curable resin 92A. In this case, the first curable resin 91A and the second curable resin 92A can be cured by radiating light (e.g., ultraviolet ray) thereon instead of heat.

In the embodiment explained above, the curable resin is described as “being cured” even if the curing rate of the curable resin is less than 100% (e.g., the curable resin is semi-cured).

### Second Embodiment

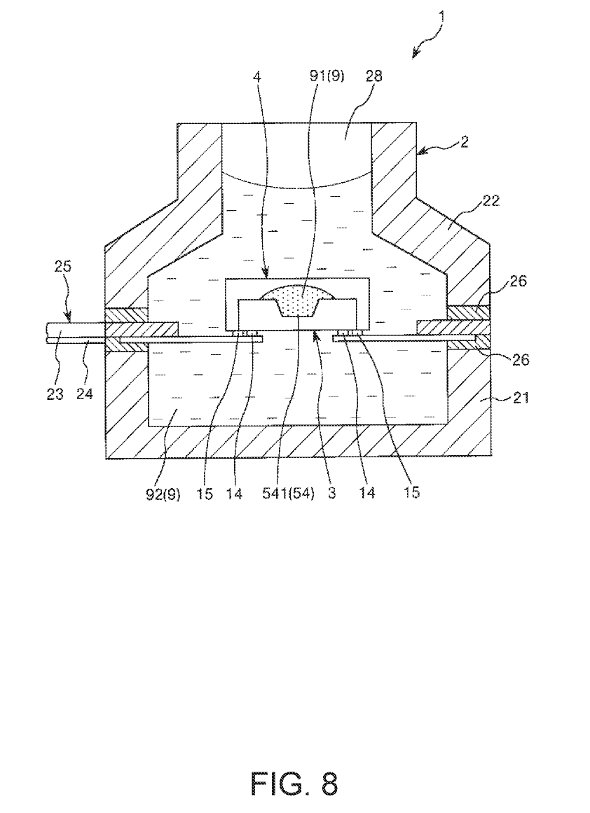

FIG. 8 is a sectional view of a pressure sensor according to a second embodiment of the invention.

The pressure sensor according to the second embodiment is explained below. Differences from the first embodiment are mainly explained. Explanation of similarities is omitted.

The pressure sensor 1 in the second embodiment is the same as the pressure sensor 1 in the first embodiment except that the direction of a pressure sensor element in a package is different.

As shown in FIG. 8, in the pressure sensor 1 in this embodiment, the pressure sensor element 3 is housed in the package 2 in a posture in which the pressure receiving surface 541 of the diaphragm 54 is directed to the opening side of the package 2. By adopting such disposition, the pressure receiving surface 541 can be set close to the opening of the package 2. Therefore, pressure applied to the pressure sensor 1 more efficiently acts on the pressure receiving surface 541.

According to the second embodiment, it is possible to exhibit effects same as the effects of the first embodiment.

### Third Embodiment

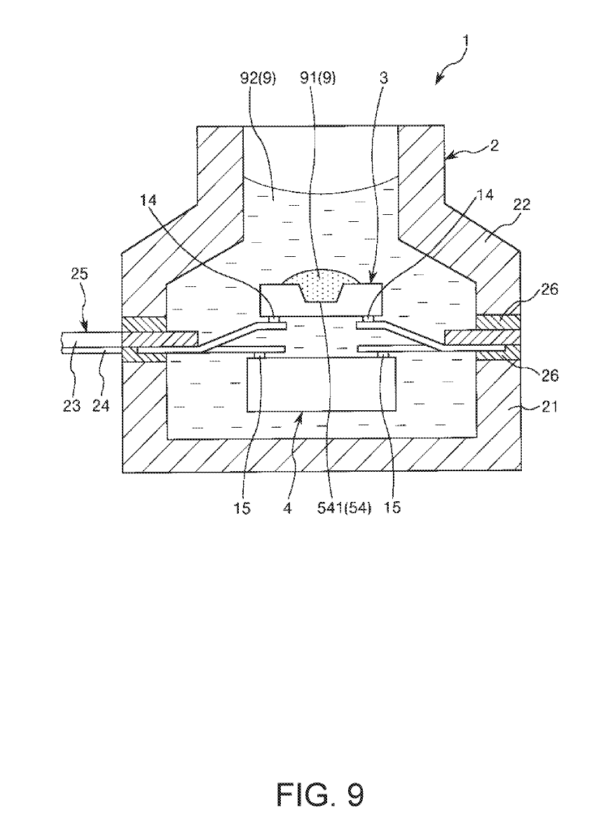

FIG. 9 is a sectional view of a pressure sensor according to a third embodiment of the invention.

The pressure sensor in the third embodiment is explained below. Differences from the embodiments explained above are mainly explained. Explanation of similarities is omitted.

The pressure sensor 1 in the third embodiment is the same as the pressure sensor 1 in the first embodiment except that disposition of a pressure sensor element and an IC chip in a package is different.

As shown in FIG. 9, in the pressure sensor 1 in this embodiment, the pressure sensor element 3 and the IC chip 4 are disposed to overlap each other in the thickness direction. Consequently, it is possible to suppress a planar spread of the pressure sensor 1. It is possible to attain a reduction in the size of the pressure sensor 1. Note that, in this embodiment, the pressure sensor element 3 is disposed on the upper side of the IC chip 4. Conversely, the pressure sensor element 3 may be disposed on the lower side of the IC chip 4.

According to the third embodiment, it is possible to exhibit effects same as the effects of the first embodiment.

### Fourth Embodiment

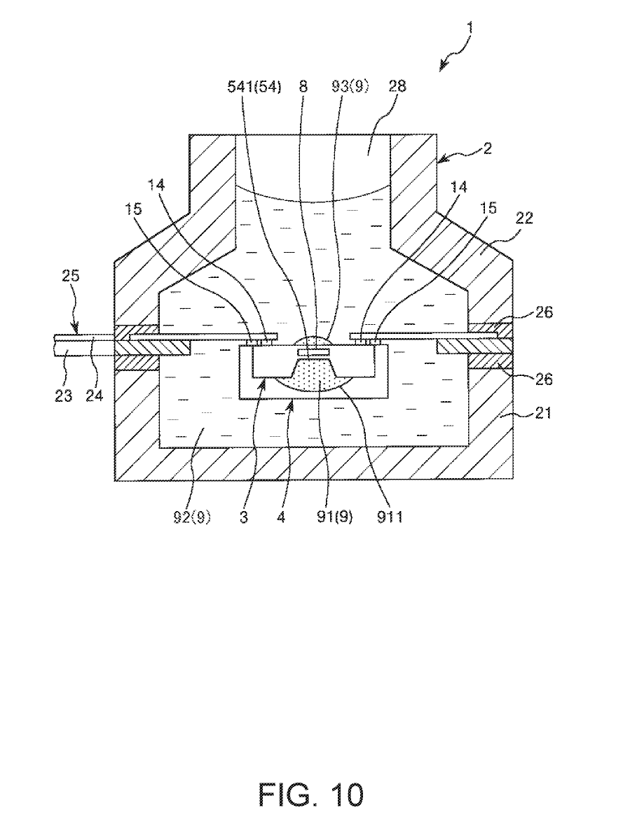

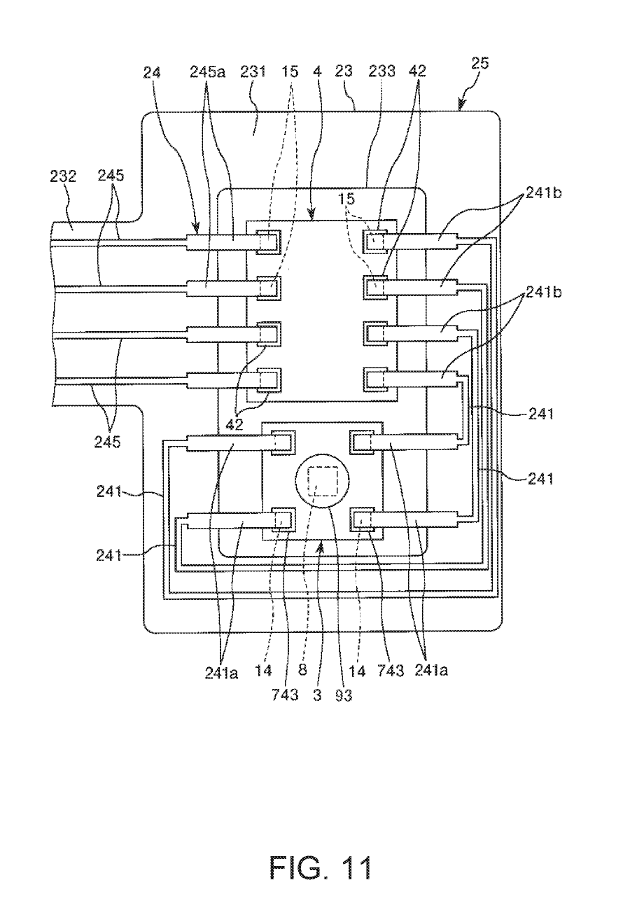

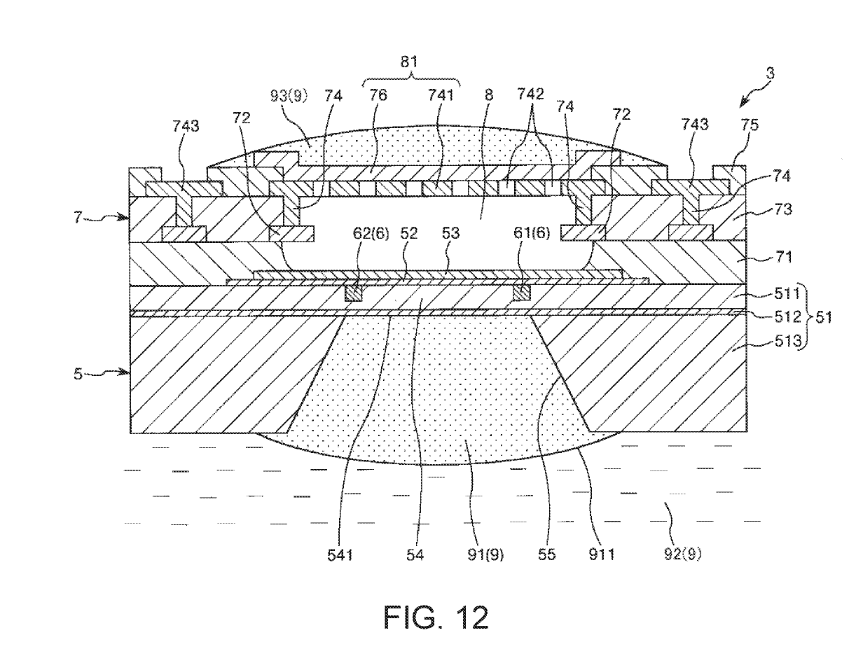

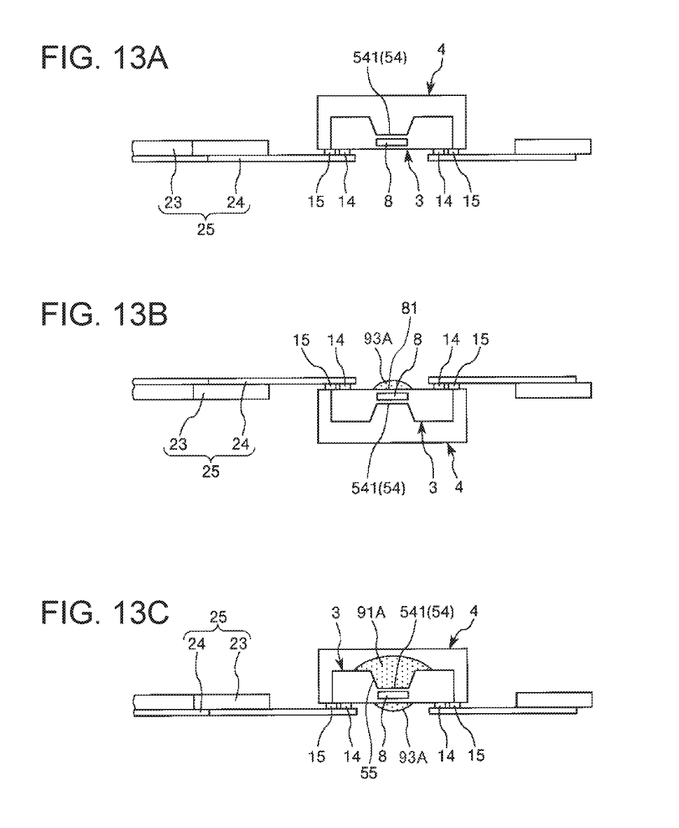

FIG. 10 is a sectional view of a pressure sensor according to a fourth embodiment of the invention. FIG. 11 is a plan view of a flexible wiring board included in the pressure sensor shown in FIG. 10. FIG. 12 is a sectional view of a pressure sensor element included in the pressure sensor shown in FIG. 10. FIGS. 13A to 15 are sectional views for explaining a method of manufacturing the pressure sensor shown in FIG. 10. Note that, in the following explanation, the upper side in the figures is referred to as “upper” as well and the lower side is referred to as “lower” as well.

The pressure sensor in the fourth embodiment is explained below. Differences from the embodiments explained above are mainly explained. Explanation of similarities is omitted.

The pressure sensor 1 in the fourth embodiment is the same as the pressure sensor 1 in the first embodiment except that the filler 9 includes the first portion 91 disposed on the pressure receiving surface 541 of the pressure sensor element 3, a third portion 93 disposed on the opposite side of the diaphragm 54 with respect to the hollow section 8 (the pressure reference chamber), and the second portion 92 located around the first portion 91 and the third portion 93 and surrounding the first portion 91, the third portion 93, and the pressure sensor element 3. That is, in the pressure sensor 1 in the fourth embodiment, the filler 9 includes the third portion 93 in addition to the first portion 91 and the second portion 92 (see FIGS. 10 to 12).

In this embodiment, as shown in FIG. 10, the filler 9 includes three portions (regions) having different curing rates (resin hardness levels). Specifically, the filler 9 includes the first portion 91 that is in contact with the pressure receiving surface 541 of the pressure sensor element 3 and an inner side surface joined to the periphery of the pressure receiving surface 541 in the recess 55 and is disposed to fill the recess 55, the third portion 93 disposed on a ceiling section 81 (apart of a wall section defining the hollow section 8) of the pressure sensor element 3, that is, on the opposite side of the diaphragm 54 with respect to the hollow section 8 to include the ceiling section 81 (the hollow section 8) in plan view, and the second portion 92 located around the first portion 91 and the third portion 93 and surrounding the first portion 91, the third portion 93, and the pressure sensor element 3. Curing rates of the first portion 91 and third portion 93 are substantially equal. Further, the curing rates of the first portion 91 and the third portion 93 are higher than a curing rate of the second portion 92. That is, the first portion 91 and the third portion 93 are harder (have lower penetration) than the second portion 92. Note that the first portion 91, the second portion 92, and the third portion 93 contain resin materials of the same kind as main components. Only the curing rates (hardness levels) of the first portion 91, the second portion 92, and the third portion 93 are substantially different.

As a constituent material of the filler 9 (the resin section), a material same as the constituent material of the filler 9 in the first embodiment can be used.

In other words, a difference between the curing rate of the first portion 91 and the curing rate of the third portion 93 can also be considered to be smaller than a difference between the curing rate of the first portion 91 and the curing rate of the second portion 92 and a difference between the curing rate of the third portion 93 and the curing rate of the second portion 92.

By adopting such a configuration, first, air bubbles less easily come into contact with the pressure receiving surface 541. It is possible to reduce fluctuation and deterioration in pressure detection accuracy. Therefore, the pressure sensor 1 can show excellent pressure detection accuracy. Specifically, air bubbles sometimes occur in the filler 9 when the filler 9 is filled in the internal space 28. If the air bubbles move in the filler 9 and come into contact with the pressure receiving surface 541, the air bubbles act like a cushion. Pressure is not appropriately transmitted to the pressure receiving surface 541 in a portion where the air bubbles come into contact with the pressure receiving surface 541. Therefore, if the air bubbles come into contact with the pressure receiving surface 541, fluctuation and deterioration in pressure detection accuracy occur.

On the other hand, in the pressure sensor 1 in this embodiment, since the curing rate of the first portion 91 that covers the pressure receiving surface 541 is higher than the curing rate of the second portion 92. Therefore, for example, intrusion of air bubbles into the first portion 91 from the second portion 92 and movement of the air bubbles in the first portion 91 are effectively suppressed. Therefore, the air bubbles less easily come into contact with the pressure receiving surface 541. It is possible to reduce fluctuation and deterioration in pressure detection accuracy.

Second, a stress balance applied to the hollow section 8 less easily changes. It is possible to reduce deterioration in pressure detection accuracy with time. Specifically, on the lower side (the pressure receiving surface 541 side) of the hollow section 8, the first portion 91 is disposed on the pressure receiving surface 541. On the upper side (the ceiling section 81 side), the third portion 93 is disposed on the ceiling section 81. Since the first portion 91 and the third portion 93 have high curing rates (curing of the first portion 91 and the third portion 93 is advanced) compared with the second portion 92, a change in the curing rate (a hardness degree) with time after that is less compared with the second portion 92. Therefore, a stress balance on both sides (the upper side and the lower side in FIG. 10) across the hollow section 8 less easily changes. The hollow section 8 can maintain a stable state. Therefore, it is possible to reduce deterioration in the pressure detection accuracy with time of the pressure sensor 1.

The curing rates of the first portion 91, the second portion 92, and the third portion 93 are not particularly limited as long as the curing rates of the first portion 91 and the third portion 93 are higher than the curing rate of the second portion 92. The curing rates of the first portion 91, the second portion 92, and the third portion 93 are different depending on materials. For example, the curing rates of the first portion 91 and the third portion 93 are desirably within a range of 40% or more and 90% or less and more desirably within a range of 50% or more and 80% or less. The curing rate of the second portion 92 is desirably within a range of 10% or more and 60% or less and more desirably within a range of 20% or more and 40% or less. By setting the curing rates of the first portion 91, the second portion 92, and the third portion 93 respectively in the ranges, it is possible to set the second portion 92 to viscosity of a degree for not allowing the second portion 92 to flow out from the opening of the package 2. It is possible to set the first portion 91 to viscosity of a degree for not allowing air bubbles to move on the inside of the first portion 91. The stress balance on both the sides across the hollow section 8 much less easily changes.

The viscosities of the first portion 91, the second portion 92, and the third portion 93 are not particularly limited as long as the viscosities of the first portion 91 and the third portion 93 are higher than the viscosity of the second portion 92. For example, the penetrations of the first portion 91 and the third portion 93 are desirably within a range of 50 or more and 200 or less and more desirably within a range of 150 or more and 200 or less. The penetration of the second portion 92 is desirably within a range of 100 or more and 250 or less and more desirably within a range of 200 or more and 250 or less. Consequently, it is possible to sufficiently soften the filler 9. Pressure applied to the pressure sensor 1 efficiently acts on the pressure receiving surface 541. It is possible to effectively suppress movement of air bubbles on the inside of the first portion 91. The first portion 91 and the third portion 93 have more appropriate hardness levels. The stress balance on both the sides across the hollow section 8 much less easily changes. Note that measurement of a curing rate can be performed by measurement by an FT-IR, fluorescent measurement, and the like. Penetration can be measured by a method conforming to a test method specified in JIS K 2207.

In particular, in this embodiment, the first portion 91, the second portion 92, and the third portion 93 are formed of the materials of the same kind (the same resin materials). Therefore, the filler 9 has a simpler configuration. It is easier to adjust the curing rates of the first portion 91, the second portion 92, and the third portion 93. In this embodiment, since the first portion 91 is disposed to fill the entire region of the recess 55, it is possible to set the second portion 92 sufficiently away from the pressure receiving surface 541. Therefore, the air bubbles much less easily come into contact with the pressure receiving surface 541. It is possible to further reduce the fluctuation and deterioration in the pressure detection accuracy. In this embodiment, since the first portion 91 is kept at a minimum enough for filling the entire region of the recess 55 (as shown in FIG. 12, the first portion 91 does not cover the entire region of the lower surface of the substrate 5, i.e., covers only the periphery of the recess 55 excluding edge portions of the lower surface), pressure is prevented from being less easily transmitted to the pressure receiving surface 541.

In this embodiment, the third portion 93 has the curing rate substantially the same as the curing rate of the first portion 91. Therefore, the stress balance on both the sides across the hollow section 8 is further stabilized. In particular, in this embodiment, since the third portion 93 is disposed to include the ceiling section 81 (the hollow section 8) in plan view, the effects explained above are more conspicuous. However, the curing rate of the third portion 93 may be different from the curing rate of the first portion 91 as long as the curing rate of the third portion 93 is higher than the curing rate of the second portion 92. A part (e.g., an edge portion) of the ceiling section 81 may protrude from the third portion 93.

The first portion 91 is desirably subjected to defoaming treatment. Consequently, it is possible to remove air bubbles in the first portion 91. Therefore, it is possible to effectively prevent the air bubbles in the first portion 91 from coming into contact with the pressure receiving surface 541. Note that the defoaming treatment is not particularly limited. Examples of the defoaming treatment include a method of performing evacuation explained in a manufacturing method below.

Note that, in this embodiment, the first portion 91 and the third portion 93 are formed as separate bodies and are separated from each other. However, for example, the first portion 91 and the third portion 93 may be joined (integrated). The pressure sensor element 3 may be covered with the first portion 91 and the third portion 93.

A method of manufacturing the pressure sensor 1 in this embodiment is explained.

The method of manufacturing the pressure sensor 1 includes a step of preparing the pressure sensor element 3, the first curable resin 91A, the second curable resin 92A, a third curable resin 93A, a step of disposing the first curable resin 91A on the pressure receiving surface 541 of the pressure sensor element 3 and disposing the third curable resin 93A in the ceiling section 81, a step of curing (semi-curing) the first curable resin 91A and the third curable resin 93A, a step of disposing the pressure sensor element 3 in the package 2, and a step of disposing the second curable resin 92A in the package 2 to surround the pressure sensor element 3, the first curable resin 91A, and the third curable resin 93A and curing (semi-curing) the first curable resin 91A, the second curable resin 92A, and the third curable resin 93A disposed in the package 2.

The manufacturing method is explained in detail below. For convenience of explanation, as the first curable resin 91A, the second curable resin 92A, and the third curable resin 93A, the same thermosetting resin is used. Curing rates of the first curable resin 91A, the second curable resin 92A, and the third curable resin 93A before being served for manufacturing are equal to one another.

First, as shown in FIG. 13A, the pressure sensor element 3 and the IC chip 4 are connected to the flexible wiring board 25.

Subsequently, as shown in FIG. 13B, the third curable resin 93A is supplied onto the ceiling section 81 in a state in which the ceiling section 81 is directed to the upper side in the vertical direction. As shown in FIG. 13C, the pressure sensor element 3 is turned over. The first curable resin 91A enough for filling the recess 55 is supplied into the recess 55 in a state in which the pressure receiving surface 541 (the opening of the recess 55) is directed to the upper side in the vertical direction. Note that, if the third curable resin 93A drips when the pressure sensor element 3 is turned over, before the pressure sensor element 3 is turned over, heat may be applied to the third curable resin 93A to cure the third curable resin 93A not to drip. However, in that case, the curing rate of the first portion 91 and the curing rate of the third curable resin 93A are set different from each other.

Subsequently, in a state in which the pressure receiving surface 541 (the opening of the recess 55) is directed to the upper side in the vertical direction, the pressure sensor element 3 is disposed in a vacuum chamber and evacuated to defoam the first curable resin 91A. Consequently, air bubbles are removed from the first curable resin 91A. Heat is applied to the first curable resin 91A and the third curable resin 93A under the same condition to semi-cure the first curable resin 91A and the third curable resin 93A. For example, when the first curable resin 91A and the third curable resin 93A are silicone oil (having a curable rate of 0%), the first curable resin 91A and the third curable resin 93A are desirably semi-cured, for example, under a condition of 150°×30 minutes. Curing rates of the first curable resin 91A and the third curable resin 93A at this point are not particularly limited. The curable rates are desirably set to, for example, approximately 20% or more and 40% or less.

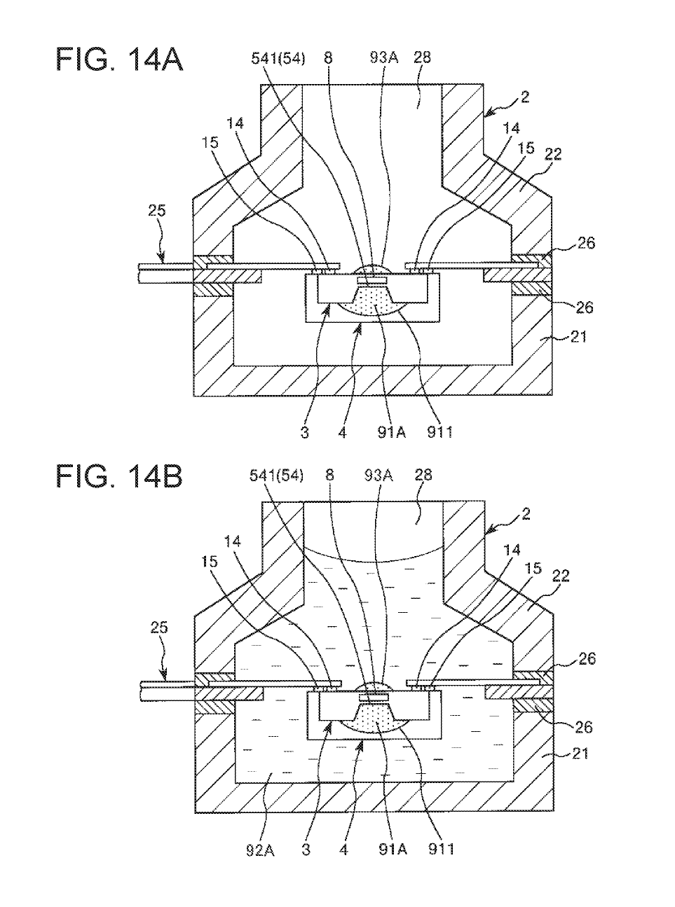

Subsequently, as shown in FIG. 14A, the flexible wiring board 25 is sandwiched by the base 21 and the housing 22. The flexible wiring board 25, the base 21, and the housing 22 are joined to one another by an adhesive. Consequently, the pressure sensor element 3 and the IC chip 4 are housed in the package 2.

Subsequently, as shown in FIG. 14B, the second curable resin 92A is filled in the internal space 28 of the package 2. The pressure sensor element 3 and the IC chip 4 are surrounded by the second curable resin 92A.

Subsequently, heat is applied to the first curable resin 91A, the second curable resin 92A, and the third curable resin 93A under the same condition to semi-cure the first curable resin 91A, the second curable resin 92A, and the third curable resin 93A. When the first curable resin 91A, the second curable resin 92A, and the third curable resin 93A are silicone oil, the first curable resin 91A, the second curable resin 92A, and the third curable resin 93A are desirably semi-cured, for example, under a condition of 150°×30 minutes. The curing rates of the first curable resin 91A and the third curable resin 93A are not particularly limited. For example, the curing rates are desirably, for example, approximately 40% or more and 90% or less. The curing rate of the second curable resin 92A is desirably, for example, approximately 10% or more and 60% or less. Note that, since the first curable resin 91A, the second curable resin 92A, and the third curable resin 93A are the resin materials of the same kind, the first curable resin 91A and the third curable resin 93A having an equal curing time have substantially equal curing rates. The first curable resin 91A and the third curable resin 93A, for which a curing time is long (curing is performed twice), have higher curing rates than the second curable resin 92A, for which a curing time is short (curing is performed only once). Consequently, the filler 9 including the first portion 91 formed of the first curable resin 91A, the second portion 92 formed of the second curable resin 92A, and the third portion 93 formed of the third curable resin 93A is obtained.

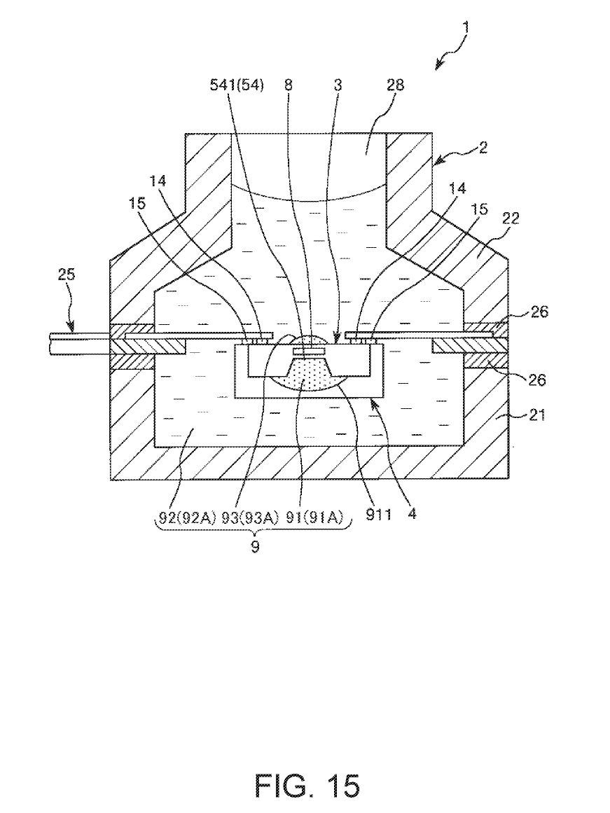

Consequently, the pressure sensor 1 is manufactured as shown in FIG. 15.

According to the manufacturing method explained above, it is possible to manufacture the pressure sensor 1 with a relatively simple method. In particular, the manufacturing method includes the step of defoaming the first curable resin 91A before curing the first curable resin 91A. Therefore, air bubbles in the first portion 91 are removed and the pressure sensor 1 having higher pressure detection accuracy is obtained. Note that, in the manufacturing method explained above, the defoaming of the second curable resin 92A may be performed prior to the curing of the first curable resin 91A, the second curable resin 92A, and the third curable resin 93A. Consequently, it is possible to sufficiently reduce the air bubbles in the second portion 92.

Note that, in this embodiment, the thermosetting resin is used as the first curable resin 91A, the second curable resin 92A, and the third curable resin 93A. However, photocurable resin may be used as the first curable resin 91A, the second curable resin 92A, and the third curable resin 93A. In this case, the first curable resin 91A, the second curable resin 92A, and the third curable resin 93A can be cured by radiating light (e.g., ultraviolet ray) thereon instead of heat.

In the embodiment explained above, the curable resin is described as “being cured” even if the curing rate of the curable resin is less than 100% (e.g., the curable resin is semi-cured).

According to the fourth embodiment explained above, it is possible to exhibit effects same as the effects of the first embodiment.

### Fifth Embodiment

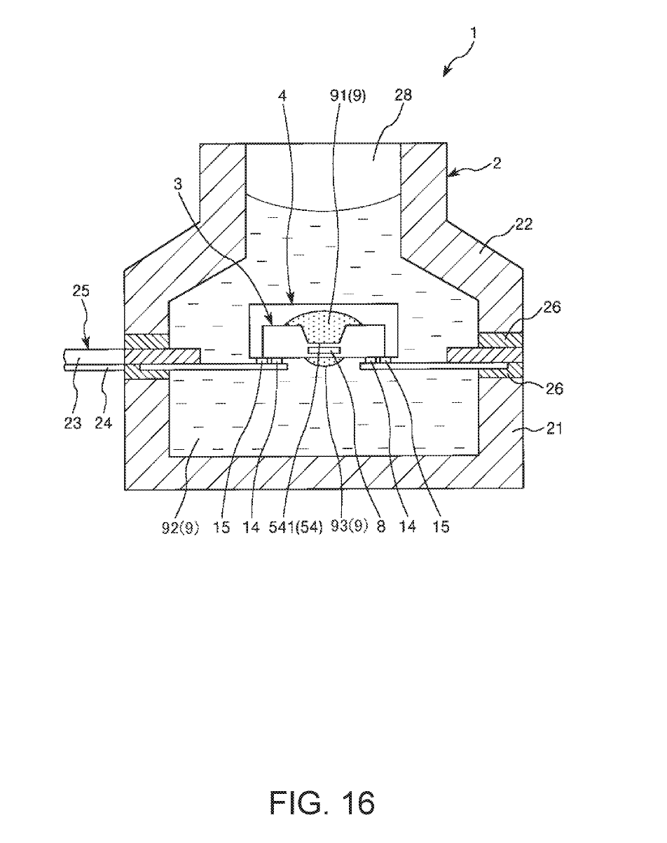

FIG. 16 is a sectional view of a pressure sensor according to a fifth embodiment of the invention.

The pressure sensor according to the second embodiment is explained below. Differences from the first embodiment are mainly explained. Explanation of similarities is omitted.

The pressure sensor 1 in the fifth embodiment is the same as the pressure sensor 1 in the fourth embodiment except that the direction of a pressure sensor element in a package is different.

As shown in FIG. 16, in the pressure sensor 1 in this embodiment, the pressure sensor element 3 is housed in the package 2 in a posture in which the pressure receiving surface 541 of the diaphragm 54 is directed to the opening side of the package 2. By adopting such disposition, the pressure receiving surface 541 can be set close to the opening of the package 2. Therefore, pressure applied to the pressure sensor 1 more efficiently acts on the pressure receiving surface 541.

According to the fifth embodiment, it is possible to exhibit effects same as the effects of the fourth embodiment.

### Sixth Embodiment

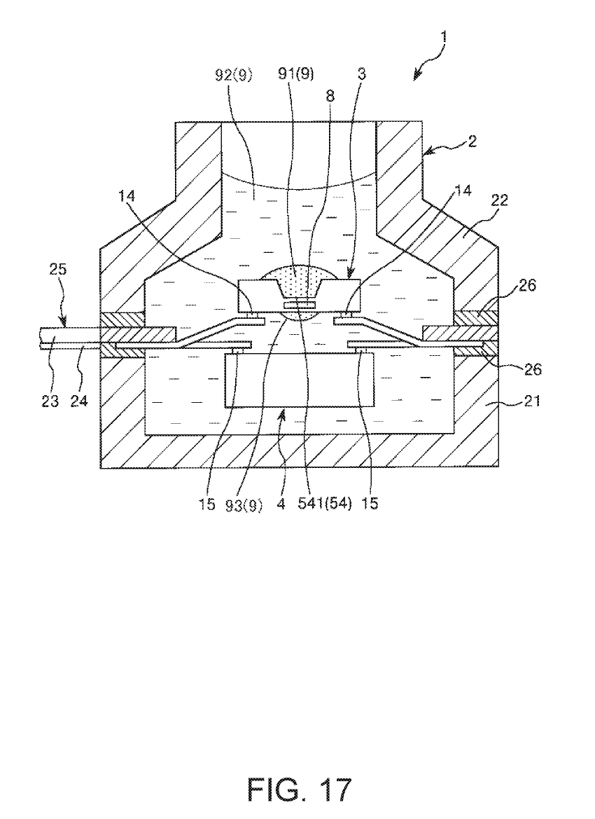

FIG. 17 is a sectional view of a pressure sensor according to a sixth embodiment of the invention.

The pressure sensor according to the sixth embodiment is explained below. Differences from the above-mentioned embodiment are mainly explained. Explanation of similarities is omitted.

The pressure sensor 1 in the sixth embodiment is the same as the pressure sensor 1 in the fourth embodiment except that disposition of a pressure sensor element and an IC chip in a package is different.

As shown in FIG. 17, in the pressure sensor 1 in this embodiment, the pressure sensor element 3 and the IC chip 4 are disposed to overlap each other in the thickness direction. Consequently, it is possible to suppress a planar spread of the pressure sensor 1. It is possible to attain a reduction in the size of the pressure sensor 1. Note that, in this embodiment, the pressure sensor element 3 is disposed on the upper side of the IC chip 4. Conversely, the pressure sensor element 3 may be disposed on the lower side of the IC chip 4.

According to the sixth embodiment, it is possible to exhibit effects same as the effects of the fourth embodiment.

### Altimeter

An example of an altimeter including a pressure sensor according to the invention is explained.

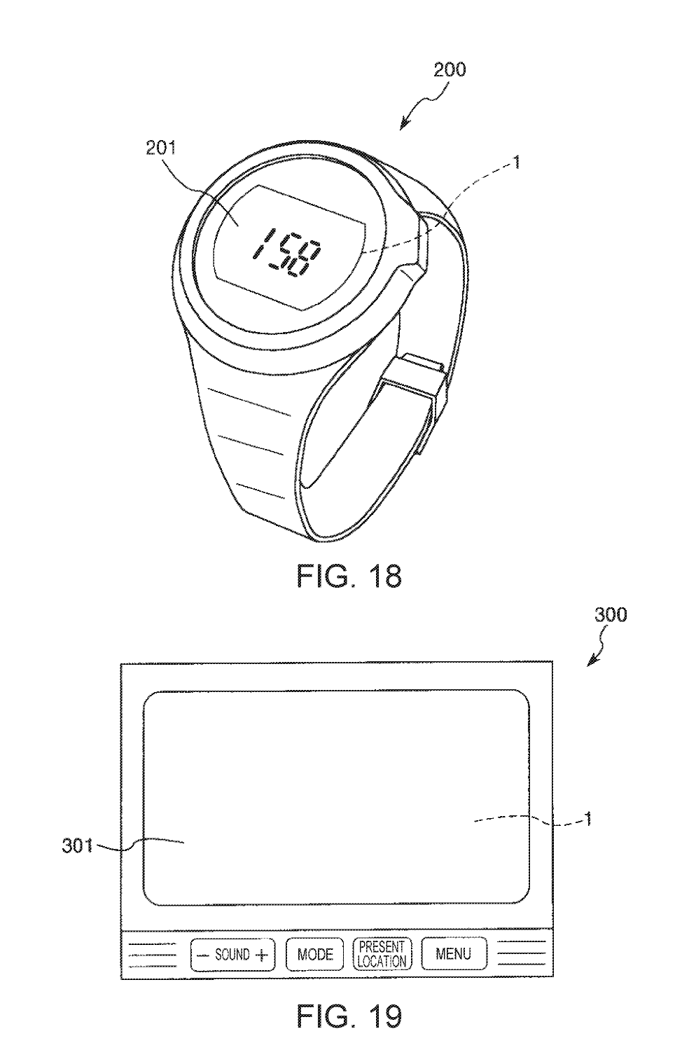

FIG. 18 is a perspective view showing the example of the altimeter according to the invention.

As shown in FIG. 18, an altimeter 200 can be worn on a wrist like a wristwatch. The pressure sensor 1 is mounted on the inside of the altimeter 200. Altitude from the sea level in the present location, atmospheric pressure in the present location, or the like can be displayed on a display section 201. Note that, various kinds of information such as the present time, a heart rate of a user, and weather can be displayed on the display section 201.

### Electronic Apparatus

A navigation system applied with an electronic apparatus including the pressure sensor according to the invention is explained.

FIG. 19 is a front view showing an example of the electronic apparatus according to the invention.

As shown in FIG. 19, a navigation system 300 includes not-shown map information, acquiring means for acquiring position information from a GPS (Global Positioning System), self-contained navigation means by a gyro sensor, an acceleration sensor, and vehicle speed data, the pressure sensor 1, and a display section 301 that displays predetermined position information or course information.

With the navigation system, it is possible to acquire altitude information in addition to the acquired position information. For example, when a vehicle travels on a high-level road, a position on which is substantially the same as the position on a general road in the position information, if the navigation system does not have the altitude information, the navigation system cannot determine whether the vehicle is traveling on the general road or traveling on the high-level road. The navigation system provides a user with information concerning the general road as priority information. Therefore, in the navigation system 300 according to this embodiment, the altitude information can be acquired by the pressure sensor 1. It is possible to detect an altitude change due to entrance into the high-level road from the general road and provide the user with navigation information in a traveling state on the high-level road.

Note that the electronic apparatus including the pressure sensor according to the invention is not limited to the electronic apparatus explained above. The electronic apparatus can be applied to, for example, a personal computer, a cellular phone, medical apparatuses (e.g., an electronic thermometer, a blood manometer, a blood sugar meter, an electrocardiogram apparatus, an ultrasonic diagnostic apparatus, and an electronic endoscope), various measuring devices, meters (e.g., meters for a vehicle, an airplane, and a ship), and a flight simulator.

### Moving Object

A moving object including the pressure sensor according to the invention is explained.

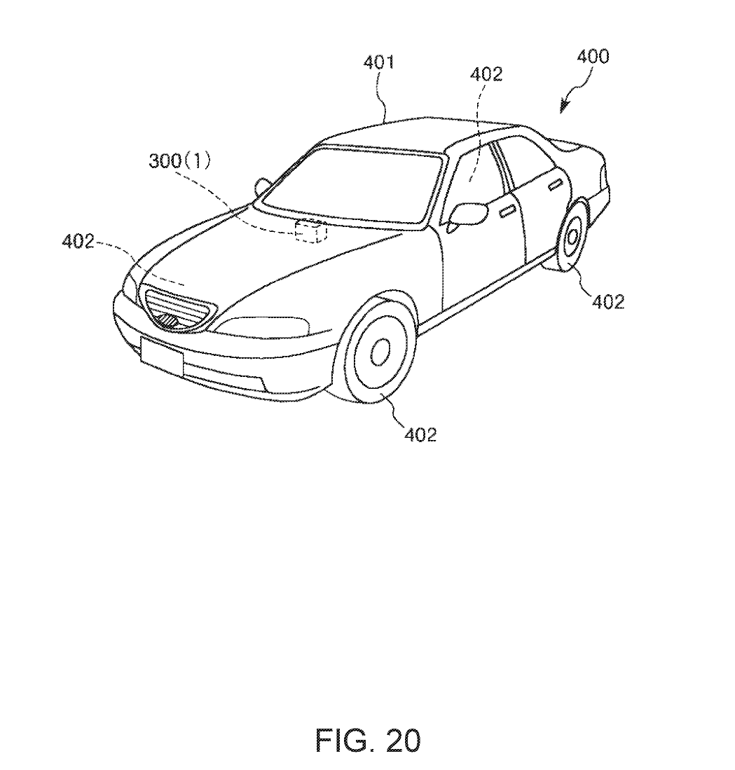

FIG. 20 is a perspective view showing an example of the moving object according to the invention.

As shown in FIG. 20, a moving object 400 includes a vehicle body 401 and four wheels 402. The moving object 400 is configured to rotate the wheels 402 with a not-shown power source (an engine) provided in the vehicle body 401. The navigation system 300 (the pressure sensor 1) is incorporated in the moving object 400.

The pressure sensor, the method of manufacturing the pressure sensor, the altimeter, the electronic apparatus, and the moving object according to the invention are explained above with reference to the embodiments shown in the figures. However, the invention is not limited to pressure sensor, the method of manufacturing the pressure sensor, the altimeter, the electronic apparatus, and the moving object. For example, the components of the sections can be replaced with any components having the same functions. Any other components and steps may be added. The embodiments may be combined as appropriate.

In the embodiments, the pressure sensor including the piezoelectric resistance elements is explained as the pressure sensor section. However, the pressure sensor section is not limited to the pressure sensor. For example, a component including a flap-type vibrator, other MEMS vibrators such as an inter digital transducer, and vibration elements such as a quartz vibrator can also be used.

In the embodiments, the wiring sections, the pressure sensor element, and the IC chip are connected by the flying leads. However, a method of connecting the wiring sections, the pressure sensor element, and the IC chip is not limited to the connection by the flying leads. The pressure sensor element and the IC chip may be connected via, for example, a bonding wire.

In the embodiments, the pressure sensor includes the IC chip. However, the IC chip may be omitted.

What is claimed is:

1. A pressure sensor comprising:
a pressure sensor element having a pressure receiving surface; and
a resin section disposed around the pressure sensor element and formed of curable resin, wherein
the resin section includes a first portion disposed at least on the pressure receiving surface and a second portion separate from the first portion, and
a curing rate of the first portion is higher than a curing rate of the second portion.

2. The pressure sensor according to claim 1, wherein the first portion and the second portion respectively contain resin materials of a same kind.

3. The pressure sensor according to claim 1, wherein
the pressure sensor element includes a recess, a bottom surface of which is the pressure receiving surface, and
the first portion is disposed to be connected to an inner side surface joined to the bottom surface in the recess.

4. The pressure sensor according to claim 1, wherein the curable resin is cured by heat.

5. The pressure sensor according to claim 1, wherein the curable resin is cured by light.

6. The pressure sensor according to claim 1, further comprising a package configured to house the pressure sensor element and the resin section.

7. The pressure sensor according to claim 6, wherein
the package has an opening, and
the pressure sensor element is disposed with the pressure receiving surface directed to a direction different from a direction of the opening.

8. The pressure sensor according to claim 1, wherein the first portion is subjected to defoaming treatment.

9. The pressure sensor according to claim 1, wherein
the pressure sensor element includes a diaphragm having the pressure receiving surface and a pressure reference chamber disposed on an opposite side of the pressure receiving surface with respect to the diaphragm,
the resin section further includes at least a third portion disposed on an opposite side of the diaphragm with respect to the pressure reference chamber,
the second portion is disposed around the first portion and the third portion, and
a curing rate of the first portion and a curing rate of the third portion are higher than a curing rate of the second portion.

10. The pressure sensor according to claim 9, wherein a difference between the curing rate of the first portion and the curing rate of the third portion is smaller than a difference between the curing rate of the first portion and the curing rate of the second portion and a difference between the curing rate of the third portion and the curing rate of the second portion.

11. The pressure sensor according to claim 9, wherein the first portion, the second portion, and the third portion respectively contain resin materials of the same kind.

12. A method of manufacturing a pressure sensor comprising:
preparing a pressure sensor element having a pressure receiving surface, a package, first curable resin, and second curable resin including a component same as a component of the first curable resin;
disposing the first curable resin on the pressure receiving surface;
curing the first curable resin;
disposing the pressure sensor element in the package;
disposing the second curable resin in the package to surround the pressure sensor element and the first curable resin; and
curing the first curable resin and the second curable resin disposed in the package.

13. A method of manufacturing a pressure sensor comprising: preparing a pressure sensor element including a diaphragm having a pressure receiving surface and a pressure reference chamber disposed on an opposite side of the pressure receiving surface with respect to the diaphragm, a package, and first curable resin, second curable resin, and third curable resin including a same component one another;
disposing the first curable resin on the pressure receiving surface and disposing the third curable resin on an opposite side of the diaphragm with respect to the pressure reference chamber;
curing the first curable resin and the third curable resin;
disposing the pressure sensor element in the package;
disposing the second curable resin in the package to surround the pressure sensor element, the first curable resin, and the third curable resin; and
curing the first curable resin, the second curable resin, and the third curable resin disposed in the package.

14. The method of manufacturing the pressure sensor according to claim 12, further comprising defoaming the first curable resin disposed on the pressure receiving surface before the curing the first curable resin.

15. An altimeter comprising the pressure sensor according to claim 1.

16. An altimeter comprising the pressure sensor according to claim 2.

17. An electronic apparatus comprising the pressure sensor according to claim 1.

18. An electronic apparatus comprising the pressure sensor according to claim 2.

19. A moving object comprising the pressure sensor according to claim 1.

20. A moving object comprising the pressure sensor according to claim 2.
